(19) United States
(12) Patent Application Publication
(10) Pub. No.: US 2002/0186706 A1
(43) Pub. Date: Dec. 12, 2002

(54) Using ATA side-band protocol for time-division multiplexing of a single ATA bus with multiple concurrent hard disks

(76) Inventors: Horng-Ming Chien, Shuh-Lin City (TW); Shang Chen Yeh, Jong-Her City (TW); Cheng-Yu Chen, Chu-Chi-Hsiang (TW)

Correspondence Address: RABIN & CHAMPAGNE, P.C., Suite 500, 1101 14th Street, N.W., Washington, DC, 20005, US

(21) Appl. No.: 09/840,985

(22) Filed: Apr. 25, 2001

(51) Int. Cl. H04L 12/43

(52) U.S. Cl. 370/461; 370/462

(57) ABSTRACT

The present invention relates to a method and a structure for ATA bus protocol compatible time-division multiplexing data transfer of single-bus and multi-drive. It mainly consists of a primary ATA bus arbiter and several ATA/HD bridges and concurrent ATA master drives. The primary ATA bus arbiter combines the bus requests of ATA bus masters to complete time-division multiplexing on the host side and allocate the ATA bus application. The ATA/HD bridges are used to respond to the on-line requests of the bus masters by switching the time-division multiplexing on the target side and resolve the possible bus contention that may be generated when two or more ATA drives are acting simultaneously. The concurrent ATA master drives will default all ATA drives as master drives under a bridge structure to allow them to become independent to each other so as to carry out respective commands and await requests from the main system individually. By means of the foregoing structure, data transfer of ATA/ATAPI device in concurrent ATA bus condition will not generate any effect on ATA/ATAPI device. Also, multi-drive explosive data transfer can now be accomplished to improve the total efficiency of the bus bandwidth by switching the time-division of single bus.

### TECHNICAL FIELD

The present invention relates to a method and a structure for ATA bus protocol compatible time-division multiplexing data transfer of single-bus and multi-drive. It is mainly a design that uses multiple concurrent ATA drives on an ATA cable to overlap the seek time, improve the performance of storage system and reduce the number of cables.

### BACKGROUND OF THE INVENTION

Basically, ATA drive is a kind of computer peripheral that comprises digital circuits, mechanical components and magnetic media. As shown in FIG. 1, the bus structure formation of a traditional ATA drive is by connecting the main system (10) with two ATA drives through an ATA cable (i.e. ATA bus (20)). Under such structure, the main system shall act as the ATA bus master and the two ATA drives on the bus shall be defined as the master drive (30) and slave drive (40), respectively. Based on the definition of PIO interface specified in bus specification, the I/O ports of ATA drive can be differentiated into control register group and command register group. This means that the main system (10) controls the operation of ATA drives through the register I/O interface. Also, based on ATA bus timing protocol and its applicable sites, ATA data access can be differentiated into the following two types:

(1) PIO Data Transfer

The main system reads and writes ATA register (address at IFO) through PIO timing protocol to complete data transfer. The definition of actual bus timing is shown in FIG. 2. The time line shown is the basic work cycle in PIO mode.

(2) DMA Data Transfer

In this case, the main system transfers data explosively through DMA timing protocol. The definition of actual bus timing is shown in FIG. 3. The DMA cycle defined by the protocol may include data sequences of various lengths. In this example, the length of the data sequence is 2.

Since there are many mechanical motions in the operation, motions, such as seek/rotation and read/write, become time wasting and inefficient. Also, motions of ATA drive can be clearly observed from its operation. It is found from experiments that the internal read/write speed of ATA drive is far slower than the maximum bandwidth of ATA bus (100 MB/s), indicating that 35 MB/s is the maximum overall data transfer rate of ATA bus. Therefore, ATA drive is a peripheral having high latency and low transfer rate.

By the time line for ATA data transfer under general bus protocol shown in FIG. 4, the whole execution of an ATA I/O request and the time requests included in each stage are described:

Period 1: Software Setup Time. Then, the main system (10) will prepare a complete command request before transferring it to the ATA secondary systems (30 and 40) through a bus.

Period 2: Access Time. Then, the ATA drive will carry out magnetic track search and the magnetic disk will rotate to the data initial magnetic area. Normally, the unit for work time required in access cycle is ms (mini second) The access time usually is 5˜10 ms.

Period 3: Data Transfer Time. Data are accessed by storage media and transferred through ATA interface. It will need a waiting time of 1˜2 ms if track changing is required in the transfer cycle. Therefore, quite a few bus standby times may be put into the whole cycle.

Period 4: Completion Time. Then, all peripherals and operation systems shall report the execution results to the application program.

The I/O performance of ATA secondary systems has always been the bottleneck for improving the overall performance of computer system. On the other hand, the coordination between the bus operation and the characteristics of ATA drive has a great influence on the I/O performance. Hence, before starting looking for solutions, analysis on devices and bus can surely help finding the cause of each problem.

As far as bus is concerned, when the main system needs to carry out I/O command of ATA/ATAPI device, the control procedure can divide the bus application in three stages to execute the following works:

1. Setting of Control Register (standard address at 1F1h˜1F6h)

2. Setting of Command Register (standard address at 1F7h)

3. Data Transfer

In the control procedure, except data transfer where the transfer mode can be decided based on the I/O command type, PIO mode must be used to read/write all related settings of ATA registers. From the existing ATA bus protocol, it can be found that the main system carries out I/O commands sequentially and no acting ATA drive is allowed to release bus during the whole command execution to provide various ATA drives with real-time bus application. Under such ATA bus (20) arrangement, in order to increase the data transfer rate to the maximum bandwidth effectively, it is necessary to apply a new bus structure to improve the flexibility in bus application.

Traditionally, a control cable, instead of the original ATA bus (20) may be applied to add the characteristic of time-division multiplexing excluded in standard specification to ATA bus (20) and maintain the compatibility with ATA standard specification. Therefore, apart from providing an extra special circuit on the main system side, an extra control cable is also required. Then, not only the design cost will be increased but also the system radiation current will be affected due to excessive cables. Furthermore, hazards in the integration between the ATA interface and the system will also be caused

Thus, the present invention mainly aims to provide a method and a structure for ATA bus protocol compatible time-division multiplexing data transfer of single-bus and multi-drive. It includes a primary ATA bus arbiter and several ATA/HD bridges and concurrent ATA master drives. The primary ATA bus arbiter combines the bus requests of ATA bus master to accomplish the time-division multiplexing on the host side and allocate the ATA bus application. By switching the time-division multiplexing on the target side, the ATA/HD bridges respond to the on-line requests of the bus master to resolve the possible bus contention generated when two or more ATA drives are acting simultaneously. Under the bridge structure, all ATA drives are defaulted as concurrent ATA master drives so that they are independent to each other and can carry out respective commands and await requests from the main system individually. By means of the foregoing structure, no effect will be generated on the ATA/ATAPI device during data transfer under concurrent ATA buses. Then, by switching the time-division of a single bus, multi-drive explosive data transfer can be accomplished to improve the total efficiency of the bus bandwidth.

Another purpose of the present invention is to identify the specific external cooperative mechanism (a specific hardware, software, ASIC or FPGA) through the read or setting procedure of a specific control register generated by the software during the first stage of software setting. When the bridge identifies the specific procedure, it will control the read/write setting of a specific control register in a breaker and switch the setting to allow other external mechanisms to provide data. Thus, standard ATA bus can be used to monitor external variables.

The structural design and technical principles of the invention are described in details below. Please refer to the attached drawings for more understanding on the specialties of the invention.

### BRIEF DESCRIPTION OF THE DRAWINGS

FIG. 1 is the structure drawing of a traditional ATA bus.

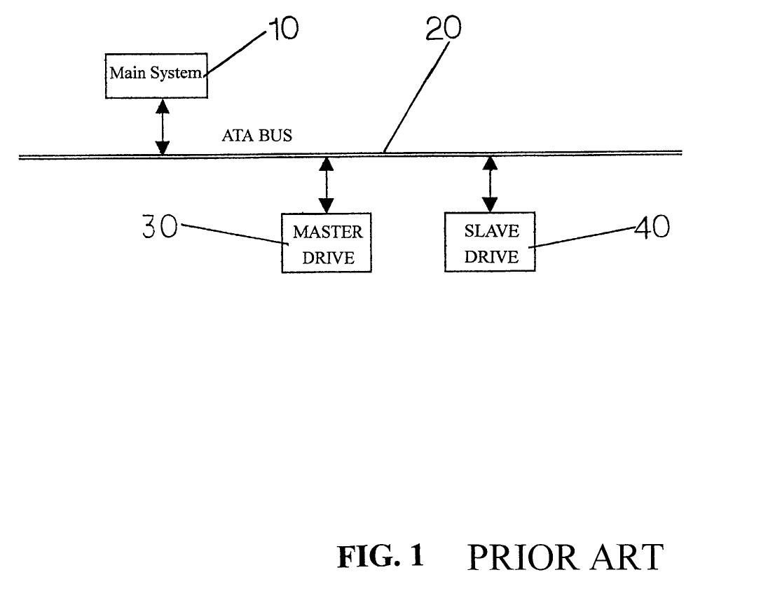

FIG. 2 is the time line for PIO data transfer of a traditional bus.

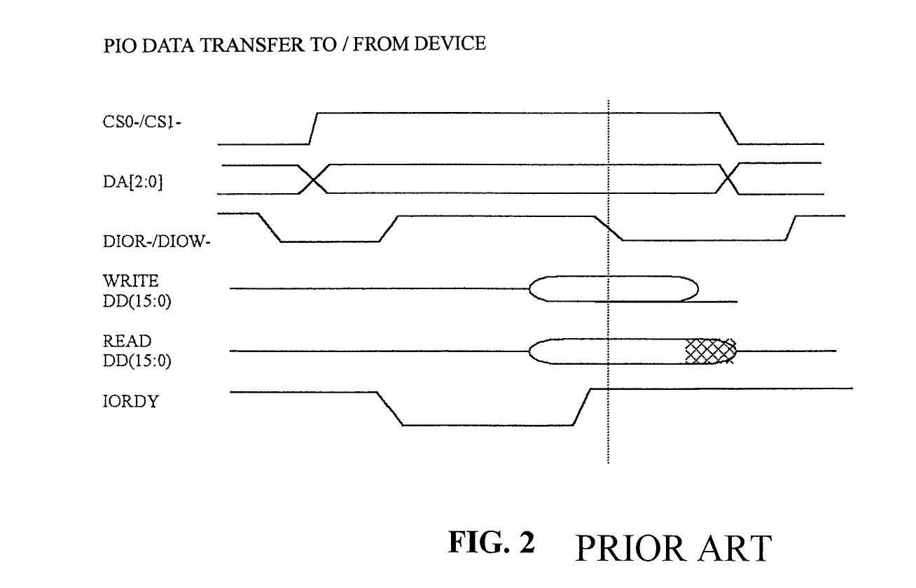

FIG. 3 is the time line for DMA data transfer of a traditional bus.

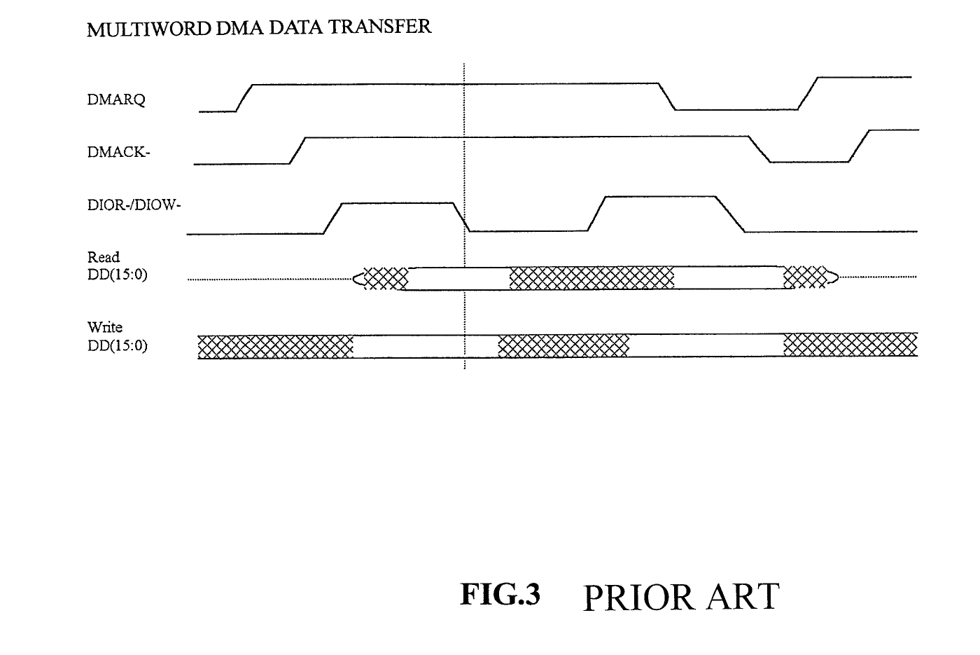

FIG. 4 is the time line during ATA data transfer under a traditional bus protocol.

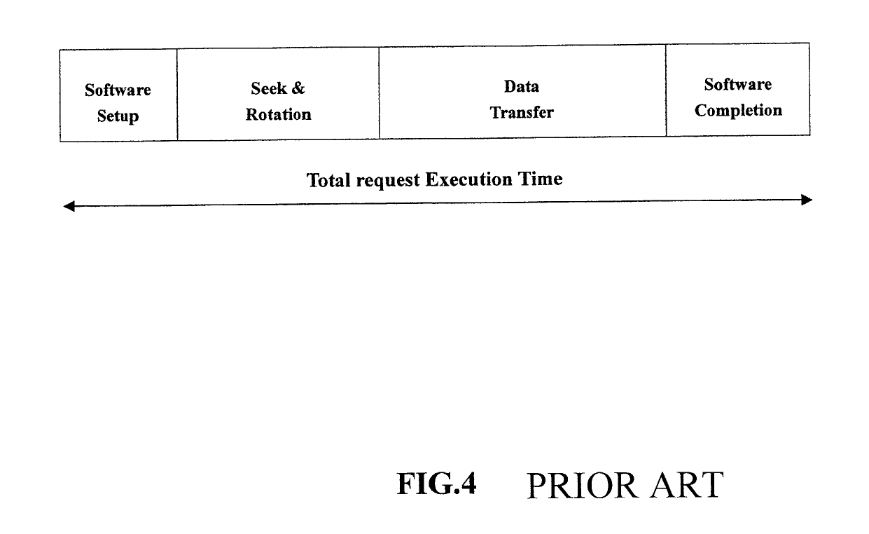

FIG. 5 is the time line for the invention during time-division multiplexing on I/O request of two ATA drives.

FIG. 6 is the structural drawing of the ATA bus defined by this invention.

FIG. 7 is a schematic diagram for the structure of the cooperation between the invention and an external mechanism.

FIG. 8 is the flowchart for hardware protocol selection of this invention.

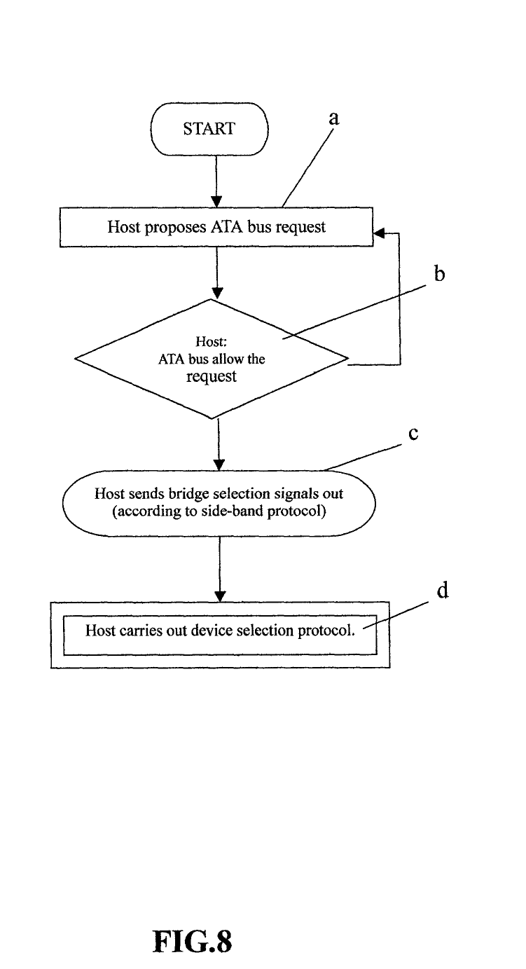

### BRIEF DESCRIPTION OF ITEMS

10 main system

30 master drive

50 bridge ATA bus structure

61 ATA bus master

71 breaker

73 fan

20 ATA bus

40 slave drive

60 primary ATA bus arbiter

70 ATA/HD bridge

72 ATA/ATAPI device

80 ATA master drive

### DETAILED DESCRIPTION OF THE INVENTION

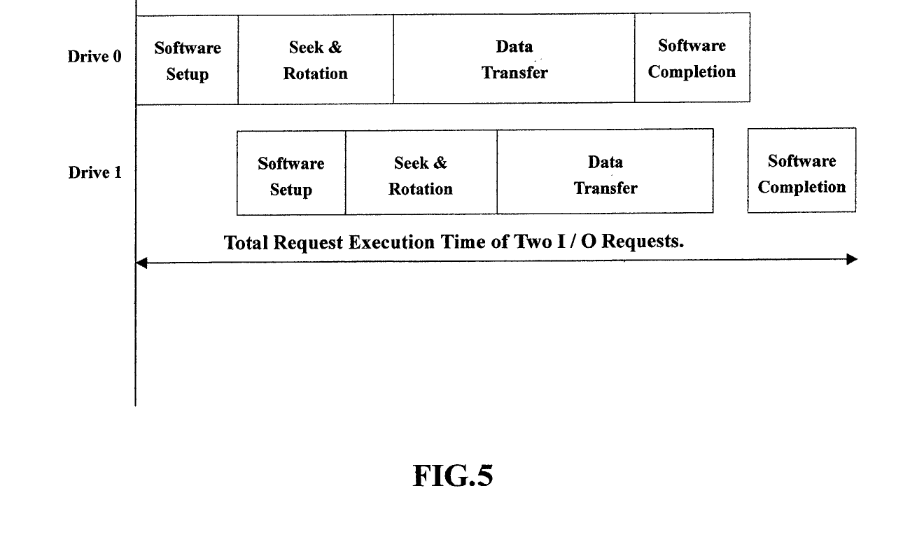

It can be understood from the operation of ATA secondary systems that, on the same ATA bus (20), no ATA drive is allowed to perform concurrent I/O command during command execution to share bus application with another ATA drive. Then, the low efficiency of ATA drive will directly affect the overall data flow of the bus. In order to improve the I/O efficiency and allow ATA drives to carry out time-division multiplexing data transfer concurrently, we must create a non-latency bus application condition before the bandwidth application efficiency of ATA bus (20) can generally be improved. Thus, the waiting time of execution on the same ATA bus (20) of all ATA data I/O commands can be shortened. By integrating the time-division multiplexing of ATA secondary systems, we can also observe the efficiency of all I/O commands on the ATA bus. The performance of time line for I/O transfer with the introduction of time-division multiplexing is shown in FIG. 5:

Period 1: Software Setup Time. Then, the main system will prepare a complete command request before transferring it to ATA drive 0 through ATA bus (20).

Period 2: Access Time. Then, ATA drive 0 will carry out magnetic track search and rotate the magnetic disk to the data initial magnetic area. At the same time, ATA drive 1 will also enter the software setup time. Similarly, the main system will prepare a complete command request before transferring it to ATA drive 1 through ATA bus.

Period 3: Data Transfer Time. Then, all data are accessed by ATA drive 0 and transferred through ATA interface. At the same time, ATA drive 1 will carry out magnetic track search and rotate the magnetic disk to the data initial magnetic area.

Period 4: Completion Time. Then, ATA drive 0 and operation systems will report the execution results to the application program. At the same time, ATA drive 1 will enter data transfer time when data will be accessed by ATA drive 1 and transferred through ATA interface.

Period 5: Then, ATA drive 1 and operation systems will report the execution results to the application program.

Under time-division multiplexing condition, two ATA drives in this invention only need to go through 5 periods to accomplish I/O command data transfer. Unlike the traditional structure where a new data I/O command request can only be presented after the previous data is completed and reported, the invention has in fact improved the I/O efficiency by overlapping seek time and data transfer time.

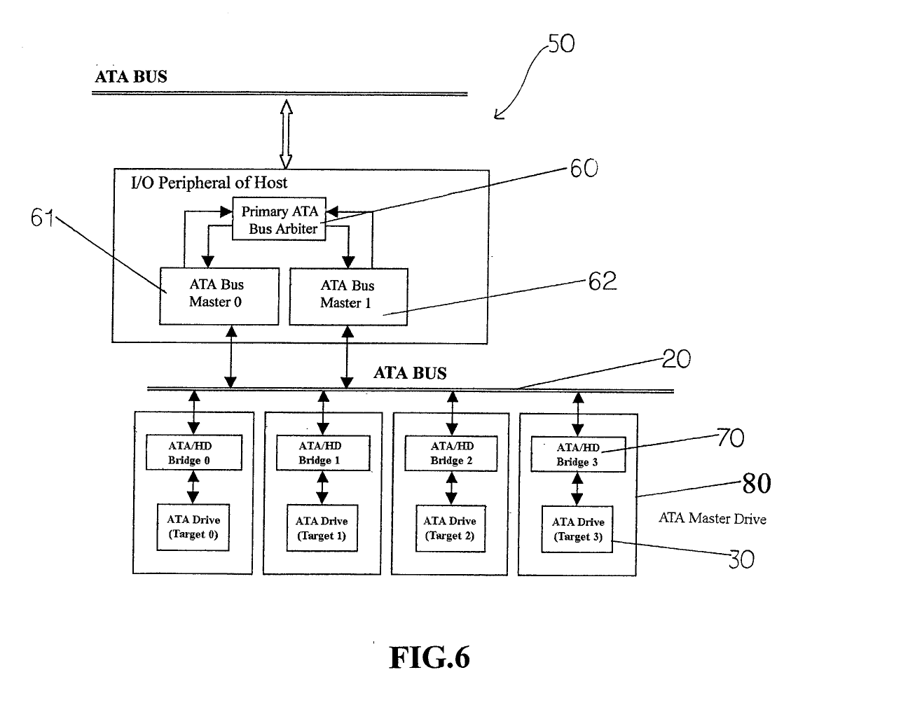

In this invention, only one ATA standard cable is required. The ATA bus structure is, thus, redefined under the condition of concurrent ATA/ATAPI device and the ATA cable. Such structure can be called as a bridge ATA bus structure (50) (as shown in FIG. 6) that includes:

A primary ATA bus arbiter (60): It combines the bus requests of ATA bus masters to complete time-division multiplexing on the host side. Since, on the ATA bus, two bus masters (ATA bus masters 61 and 62 shown in FIG. 6) exist simultaneously that may request to use the ATA bus at any time, the arbiter is required to allocate the application of the main ATA bus (20).

Several ATA/HD bridges (70): They are used to respond to the on-line requests of the bus masters by switching the time-division multiplexing on the target side. At the same time, in order to resolve the possible bus contention that may be generated when two or more ATA drives are acting simultaneously under such time-division multiplexing condition, the ATA/HD bridges (70) shall decide the connection on/off through bridge time line. Thus, the connection on/off between the target drive and the main ATA bus can be controlled.

Several concurrent ATA master drives (80): Under such bridge structure, all ATA drives are defaulted as concurrent ATA master drives so that they are independent to each other and can carry out respective commands and await requests from the main system individually.

Basically, non-ATA standard signal time line whose commands can only be identified by an external bridge (70) can be used to define an extended bus command. Therefore, external bridge (70) can use such time line to monitor the bus systems. For example, under PIO mode, a standard ATA time line must obtain selection allowed signals (CS0# and CS1#) from the register. If there is a specific time line that does not have the selection allowed signals from the register, notwithstanding it cannot be identified by the ATA/ATAPI device, the ATA/HD bridge (70) connected to it will make the identification to define the bridge command group. Therefore, if a specific hardware is equipped on the main system (10) and the specific command that cannot be identified by the ATA/ATAPI device is transferred to a bridge (70) that can identify the specific time line command, bus switch can be accomplished under specific command. Since bridges (70) guide the time-division control in the bus systems under multiplexing condition, it is necessary to redefine the device selection protocol as shown in FIG. 6.

TABLE 1

| (CS0#, CS1#) | DA[2:0] | (B0, B1, B2, B3) | Mode |
|---|---|---|---|
| 2′ b11 | 3′ b000 | (on, off, off, off) | PIO, DMA |
| 2′ b11 | 3′ b001 | (off, on, off, off) | PIO, DMA |
| 2′ b11 | 3′ b010 | (off, off, on, off) | PIO, DMA |
| 2′ b11 | 3′ b011 | (off, off, off, on) | PIO, DMA |

Step a. Host proposes ATA bus request.

Step b. Determine whether ATA bus has allowed the request. If not, host shall continue propose ATA bus request.

Step c. Host sends bridge selection signals out.

Step d. Host carries out device selection protocol according to Table 1.

Control procedure of ATA/ATAPI device can be divided into 3 stages:

1. Setting of Control Register (standard address at 1F1h˜1F6h)

2. Setting of Command Register (standard address at 1F7h)

3. Data Transfer

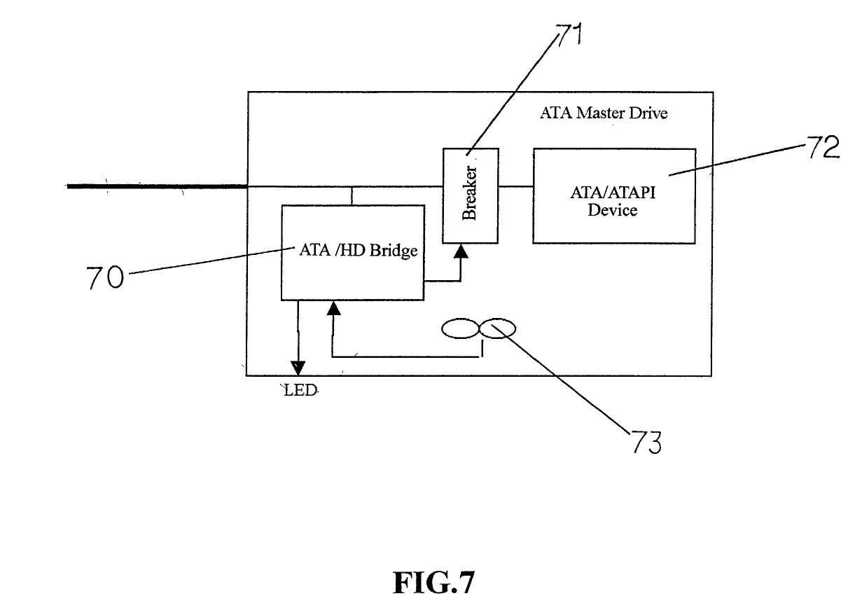

In the stage before the setup of command register, except software reset, no operation on ATA bus shall cause any error or effect on ATA/ATAPI device. Therefore, the invention will generate a specific read/setup procedure through the software for control register in the first stage. Such specific procedure can be identified by any specific external mechanism cooperating with the procedure (such mechanism may be a specific hardware, software, ASIC or FPGA) but definitely will not be generated while operating or executing in general system without going through any specific software. Since strict rules will be applied for entering external access condition of bridge (70), entry to such system parameter condition will be refused if any procedure incompliance is found. When bridge (70) identifies the specific procedure, entry to the so-called “external access condition” will be allowed. Irrelevant with ATA/ATAPI device (72), all read/write setting data of the specific control register in the external access condition will be switched for external mechanisms to provide. For example, in external access condition, data written into a control register will be stored in an external mechanism and can be used as a signal for power or LED switching. For another example, if a control register is read in external access condition, external mechanism shall provide data, such as temperature of the external connection box or operation message of fan (73) (as shown in FIG. 7). When external mechanisms are in external access condition, by means of another special “escape procedure”, so-called, the software can use a breaker (71) to make the bridge break away from the external access condition and return to its original condition. Through the procedure, standard ATA bus can be used to monitor external variables.

In summary, by means of the method and structure for ATA bus protocol compatible time-division multiplexing data transfer of single-bus and multi-drive provided in this invention, data transfer of ATA/ATAPI device in concurrent ATA bus condition will not generate any effect on ATA/ATAPI device. Also, multi-drive explosive data transfer can now be accomplished to improve the total efficiency of the bus bandwidth by switching the time-division of single bus. Furthermore, effective solutions and measures to the defects in traditional ATA bus structure and protocols have been proposed in this invention. The invention, therefore, shall have met all requirements of Patent Laws. Considerations given to this patent application will be highly appreciated.

It shall, nevertheless, be noted that the foregoing technologies, drawings, programs or controls are merely some preferred embodiments of the present invention. All identical products having equivalent changes or some functions modified or captured from any technical part within the patent scope of this application shall remain as being covered by the patent rights of the present invention but shall not limit the application scope of the present invention.

What is claimed is:

1. The invention herein is a structure for using ATA Side-Band protocol for time-division multiplexing of a single ATA bus with multiple concurrent hard disks, which includes:
a primary ATA bus arbiter: It combines the bus requests of ATA bus masters to complete time-division multiplexing on the host side, and
several ATA/HD bridges, herein they are used to respond to the on-line requests of the bus masters by switching the time-division multiplexing on the target side, thereof at the same time, in order to resolve the possible bus contention that may be generated when two or more ATA drives are acting simultaneously under such time-division multiplexing condition, the ATA/HD bridges shall decide the connection on/off through bridge time line, said the connection on/off between the target drive and the main ATA bus can be controlled, and
several concurrent ATA master drives: Under such bridge structure, all ATA drives are defaulted as concurrent ATA master drives so that they are independent to each other and can carry out respective commands and await requests from the main system individually, wherein
by means of the foregoing structure, a bridge ATA bus system is constructed to overlap the seek time and data transfer time, improve the storage system's performance and reduce the cable quantity.

2. According to claim 1 hereof, the bridge uses a non-ATA defined standard signal time line to monitor the bus system.

3. The invention herein includes:
a. host proposes ATA bus request, and
b. determine whether ATA bus has allowed the request. If not, host shall continue propose ATA bus request, and
c. host sends bridge selection signals out, and
d. host carries out device selection protocol.

4. According to claim 3 hereof, which shall also include the read/setup procedure of an external control register generated during software reset, procedure of an external control register generated during software reset, thereof such procedure shall be able to be identified by a specific external mechanism cooperating with the bridge to enter an external access condition for the read/write setup of the specific control register.

5. According to claim 4 hereof, the external mechanism is a signal of power or LED switch or a message of the external connection box's temperature or the fan's operation.

6. According to claim 4 hereof, the bridge can break away from the external access condition and return to its original condition by an escape procedure when external mechanism is in an external access condition.
